(19) United States
(12) Patent Application Publication
(10) Pub. No.: US 2007/0109822 A1
(43) Pub. Date: May 17, 2007

(54) Zero voltage switch method for synchronous rectifier and inverter

(76) Inventor: Kan-Sheng Kuan, Hsinchu (TW)

Correspondence Address: John S. Egbert;Egbert Law Offices, 7th Floor, 412 Main Street, Houston, TX, 77002, US

(21) Appl. No.: 11/273,710

(22) Filed: Nov. 14, 2005

(51) Int. Cl. H02M 3/335

(52) U.S. Cl. 363/21.14

(57) ABSTRACT

The zero voltage switch (ZVS) method for the synchronous rectifiers and inverter. The ZVS method for synchronous rectifier, in which the rectifier diode is replaced by a bi-directional-current one directional-voltage blocking capability switch, by allowing and terminating current flow in a reverse direction, achieves zero voltage turn-on on both inverter and rectifier switches. The ZVS method of the present invention includes: increasing an inductor current to a current upper limit with a first switch module active; decreasing the inductor current with the first switch module open and a second switch module passive; decreasing the inductor current with a second switch module active; turning the second switch module open when the inductor current turns negative; increasing the inductor current from a current lower limit with the first switch module passive; and increasing the inductor current with the first switch module active with zero voltage.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a zero voltage switch (ZVS) method for converters, particularly to a ZVS method based on a negative conduction mode that allows and terminates the current flow in a reverse direction, which is more suitable for switching synchronous rectifiers and inverters.

### BACKGROUND OF THE INVENTION

The conversion of AC line voltage to low DC voltage is commonly used in electronic appliances. Sometimes it is made as a separate independent module known as an adapter, which is used in a notebook PC, an LCD monitor/TV, a charger, etc. Sometimes it is embedded within the appliances, known as an open frame, such as in a desktop PC, a TV, a medium-sized charger, etc. The same technique may also be used for a DC/AC inverter such as an uninterruptible power supply (UPS), motor drives, etc.

The advance of the high-frequency switching power supply technique reduces the size of the converter, but new issues arise in which the switching noises transmit back into power lines or radiate into space. Yet, the conversion efficiency is being perfected. The high-frequency switching power conversion technique uses a switch circuit, called an inverter, to convert an unregulated voltage to a high-frequency voltage so the transformer and capacitor sizes are reduced, and its switching time is controlled so the output is regulated. The high-frequency voltage may be rectified, using a switch circuit, called a rectifier, to be a regulated DC voltage.

FIG. 1(a) shows the circuit commonly known as a buck converter 10. The node P and node N are the positive and negative poles of the input DC voltage, Vᵢₙ. Between them are an input capacitor C1 and series connecting a switch S1 with a diode D2. The switch S1 is connected to the node P, with a diode D1 as its body diode. The diode D2 is connected to the node N. A node O, the conjunction of the switch S1 and the diode D2, is connected to an output capacitor C2 through an inductor L. The node U is the output pole of the buck converter circuit 10. The node N is used as a common node for the input and the output of the basic buck converter circuit 10. FIG. 1(b) shows the inductor current I_{L} (the current flowing through the inductor L) and the voltage V_{O} at the node O and the output voltage Vₒᵤₜ. When the switch S1 is turned on, the current flows from the node P through the switch S1 and the inductor L to the node U. Meanwhile, it is linearly increasing. After tₒₙ duration, the switch S1 is turned off; so as to keep the inductor current I_{L} continuous, the current is fly-wheeling through the diode D2. In this period, the inductor current I_{L} is linearly decreasing. After t_{off} duration, the switch S1 is turned back on, and the next cycle is repeated. The switching period is tₛ(=tₒₙ+t_{off}). The duty ratio D is defined as tₒₙ/tₛ. The output voltage Vₒᵤₜ, Vo filtered by the inductor L and the output capacitor C2, is defined as the product of D and Vᵢₙ.

FIGS. 2(a) and 2(b) show the other commonly known basic circuit topologies, a boost converter circuit 12 and a fly-back converter circuit 14, respectively. When diodes and switches are treated as alike, these three basic converter circuits, the buck, boost and fly-back, are actually the same, but different in their arrangement of the input port, the output port and the control method.

Referring to FIG. 1(a), when the node P and the node N are allocated as the positive and negative poles of input, and the node U and the node N are allocated as the positive and negative poles of output, the circuit becomes the buck converter circuit 10. Referring to FIG. 2(a), when the node U and the node N are allocated as the positive and the negative poles of input, respectively, and the node P and the node N are allocated as the positive and the negative poles of output, the circuit becomes the boost converter circuit 12. Referring to FIG. 2(b), when the node U and the node N are allocated as the positive and the negative poles of input, and the node P and the node U are allocated as the positive and the negative poles of output, the circuit becomes the fly-back converter circuit 14. Mostly, the fly-back circuit is used for an AC/DC converter, where the input/output isolation is required, in turn requiring a fly-back transformer circuit 16, as shown in FIG. 2(c). Since the primary winding L1 of the fly-back transformer circuit 16 has leakage/non-linkage flux with the secondary winding L2, some flux energy stored by the primary winding L1 cannot be released at the secondary winding L2. This energy should be released at the primary winding L1; otherwise, the voltage spike will occur. Using a snubber circuit, the current of leakage flux can pass through a diode DS to a capacitor CS, and the accumulated energy is discharged through a resistor RS to become heat.

Referring to FIG. 2(c) again, in the process, just before the switch S1 is turned on, the current fly-wheels through the diode D2. When the switch S1 is turned on, the charge carrier in diode D2 cannot extinguish suddenly, but reverses direction, which is called reverse recovery. A large inrush peak current occurs, appearing to be a short circuit, which generates an electromagnetic disturbance and a switching loss, turn-on loss on the switch S1 and turn-off loss on the diode D2. To avoid it, control methods are devised so the switch's voltages swing naturally to zero before the switches are turned on, and these are called zero voltage switch (ZVS) techniques.

Referring back to FIG. 1(a), in fact, the diode D2 seems to be a switch, which operates complementarily with respect to the switch S1. So the diode D2 may be replaced by a real switch, which is controlled by a control circuit Ctr with the signal complementary to that of the switch S1, called a synchronous buck converter circuit 10′, as shown in FIG. 3(a). The switches S1, S2 may be active as MOSFET or passive as diodes. Diodes are preferred for easy controls. But a diode has an inherent 0.7 V forward voltage drop, so for efficiency, a rectifying diode is paralleled with synchronous controlled MOSFET to reduce the conduction loss, and this is called a synchronous rectifier. In fact most MOSFETs have inherent body diodes, so it does not need to actually parallel them.

Similarly, the diode D2 in the other two basic circuits may also be replaced by properly controlled switches, so they become a synchronous boost converter circuit 12′ and a synchronous fly-back transformer circuit 16′, as FIGS. 3(b) and 3(c), respectively, and FIG. 3(d) is an alternate configuration of the synchronous fly-back transformer circuit 16′ in FIG. 3(c).

In real control, to prevent a short circuit, a switch is turned off before the other is turned on, so in between, both switches are off, which is called dead time. These three synchronous basic circuits, buck, boost, and fly-back, are actually the same, but different in their arrangement of the input port, the output port and the control method. So they are discussed concurrently.

The variations of the inductor current I_{L} of the synchronous buck converter circuit 10′ at four steps (from a to d) are shown in FIG. 4(e), with their current's directions shown in FIGS. 4(a) to 4(d). The labels (a, b, c and d) in FIG. 4(e) correspond to the status of the inductor current I_{L} in FIG. 4(a) to FIG. 4(d). When the switch S1 is turned on, the inductor current I_{L} flows from the node P through the switch S1 and the inductor L to the node U. It is linearly increasing, as shown in FIG. 4(a) and FIG. (e). After tₒₙ duration, the switch S1 is turned off; to keep the inductor current I_{L} continuous, a current is fly-wheeling through the diode D2, as shown in FIG. 4(b). After this, the voltage across the switch S2 is zero. In this period, the inductor current I_{L} is linearly decreasing. After a short dead t_{d} period, the switch S2 is turned on (it means the MOSFET allows a current to flow through), and most of the current is now diverted through the switch S2, since the MOSFET of the switch S2 has a lower voltage drop than of the diode D2, as shown in FIG. 4(c). Meanwhile, the inductor current I_{L} is still decreasing. In the prior art, the switch S2 is turned off before the inductor current I_{L} is diminished, so the inductor current I_{L} flows through the diode D2, as shown in FIG. 4(d). After a short dead time, the switch S1 is turned back on while the switch D2 is conducting. Therefore, the reverse recovery current exists. A large turn-on loss occurs at the switch S1, and the turn-off loss is at the diode D2. Referring to FIG. 4(e), the value of the inductor current I_{L} at each state is positive, and it means the direction of the inductor current I_{L} does not change during these four stages.

Another problem of the prior arts is bad cross regulation. In some applications, a converter may have more than one voltage level output; for example, 3.3V, 5V, 12V, etc. However, with one control variable, usually the inverter switching time, only one output can be taken care, and the others follow. This is called bad cross regulation. To have better regulation on both outputs, a cascaded converter, post-regulation, is needed, in which another control variable is introduced to regulate the respective output. With a cascade converter, the same power is converted repeatedly, so the conversion loss is the sum, and the efficiency is reduced.

For environmental protection, high efficiency means saving energy. For makers of converters, high efficiency means reducing the size (for the heat sink) and increasing the converter lifetime. The efficiency is increased through Zero Voltage Switching (ZVS), reducing switching loss and through the synchronous rectifier, reducing conduction loss.

There are many methods on ZVS and post-regulation, but no one has taken care on both ZVS and cross regulation of a multi-output converter. In addition, in prior arts, the diode circuits are discussed and three conduction modes are known: continuous conduction, discontinuous conduction, and transition conduction. Referring to FIGS. 4(a)-4(e), when the switch S1 is on, the inductor current I_{L} increases, and when the switch S1 is off, the inductor current I_{L} fly-wheels through the diode D2, and it decreases. When the switch S1 is turned back on, the inductor current I_{L} starts increasing again, before the current diminishes to zero. Therefore, the inductor current I_{L} is never stopped, so it is called a continuous conduction mode. When the load is light or intentionally designed as so, the inductor current I_{L} diminishes to zero, and it stays zero, since the diode D2 does not allow the inductor current I_{L} to flow in a reverse direction, before the switch S1 is turned back on. This is called a discontinuous conduction mode. When the switch S1 is controlled so it always turns on once the current diminishes to zero, it is called a transition conduction mode.

### BRIEF SUMMARY OF THE INVENTION

The primary objective of the present invention is to provide a ZVS method, which is based on a negative conduction mode that allows and terminates the current flow in a reverse direction to reduce switching loss and disturbance in low conduction loss synchronous rectified converter systems and inverters, and to regulate a multi-output converter without compromising the efficiency.

In order to achieve the objective, the present invention discloses a ZVS method, applied in a buck converter, boost converter or a DC/AC inverter, comprising the steps of: (a) increasing an inductor current to a current upper limit with a first switch module active; (b) decreasing the inductor current with the first switch module open and a second switch module passive; (c) decreasing the inductor current with a second switch module active; (d) turning the second switch module open when the inductor current turns negative; (e) increasing the inductor current from a current lower limit with the first switch module passive; and (f) increasing the inductor current with the first switch module active with zero voltage.

The present invention further discloses a ZVS method, applied in a fly-back converter, comprising the steps of: (a) increasing a first current to a current upper limit with a first switch module active; (b) decreasing a second current with the first switch module open and a second switch module passive; (c) decreasing the second current with the second switch module active; (d) turning the second switch module open when the second current turns negative; (e) increasing the first current form a current lower limit with the first switch module passive; and (f) increasing the first current with the first switch module active with zero voltage.

The present invention further discloses a ZVS method, applied in a half-bridge fly-back converter or a fly-back converter with a regenerative snubber, comprising the steps of: (a) increasing a first current to a current upper limit with a first switch module active; (b) decreasing a third current with the first switch module open, a second switch module passive and a third switch module passive; (c) decreasing the third current with the third switch module active and the second switch module active; (d) turning the second switch module open when the second current turns negative; (e) increasing the first current from a current lower limit with the first switch module passive and the third switch module open; and (f) increasing the first current with the first switch module active with zero voltage.

### BRIEF DESCRIPTION OF THE SEVERAL VIEWS OF THE DRAWINGS

The invention will be described according to the appended drawings.

FIG. 1(a) shows a schematic view illustrating a buck converter circuit.

FIG. 1(b) shows a schematic view illustrating the inductor current, the voltage at the node O and the output voltage of FIG. 1(a).

FIG. 2(a) shows a schematic view illustrating a boost converter circuit.

FIG. 2(b) shows a schematic view illustrating a fly-back converter circuit.

FIG. 2(c) shows a schematic view illustrating a fly-back transformer circuit.

FIG. 3(a) shows a schematic view illustrating a synchronous buck converter circuit.

FIG. 3(b) shows a schematic view illustrating a synchronous boost converter circuit.

FIG. 3(c) shows a schematic view illustrating a synchronous fly-back transformer circuit.

FIG. 3(d) shows a schematic view illustrating an alternate configuration of FIG. 3(c).

FIGS. 4(a)-(d) show schematic views illustrating the inductor current direction of FIG. 3(a).

FIG. 4(e) shows a schematic view illustrating the variations of the inductor current of FIG. 3(a) at four steps.

FIGS. 5(a)-(f) show schematic views illustrating the inductor current direction of FIG. 3(a) when the ZVS method of the present invention is applied.

FIG. 5(g) shows schematic views illustrating the variations of the inductor current of FIG. 3(a) at six steps when the ZVS method of the present invention is applied.

FIG. 6(a) shows a schematic view illustrating a dual-phase converter circuit.

FIG. 6(b) shows a schematic view illustrating the variations of two inductor currents and the net current of FIG. 6(a) when the ZVS method of the present invention is applied.

FIGS. 7(a)-(f) show schematic views illustrating the inductor current direction of FIG. 3(b) when the ZVS method of the present invention is applied.

FIG. 7(g) shows schematic views illustrating the variations of the inductor current of FIG. 3(b) at six steps when the ZVS method of the present invention is applied.

FIGS. 8(a)-(f) show schematic views illustrating the inductor current direction of a half-bridge DC/AC inverter when the ZVS method of the present invention is applied.

FIG. 8(g) shows a schematic view illustrating an open-loop control scheme of square output current applications.

FIGS. 9(a)-(h) show schematic views illustrating the inductor current direction of a full-bridge DC/AC inverter when the ZVS method of the present invention is applied.

FIG. 9(i) shows a schematic view illustrating the variations of the inductor current of FIG. 9(a) at eight steps when the ZVS method of the present invention is applied.

FIG. 10(a) shows a schematic view illustrating an open-loop control scheme of sinusoidal output current applications.

FIG. 10(b) shows a schematic view illustrating a closed-loop control scheme of the output voltage applications.

FIG. 10(c) shows a schematic view illustrating a current limit generator.

FIGS. 11(a)-(f) show schematic views illustrating the inductor current direction of FIG. 3(d) when the ZVS method of the present invention is applied.

FIGS. 11(g)-(h) show schematic views illustrating the variations of the primary current and secondary current of FIG. 3(d) at six steps when the ZVS method of the present invention is applied.

FIG. 12 shows a schematic view illustrating a dual-output synchronized rectifier converter.

FIGS. 13(a)-(f) show schematic views illustrating the inductor current direction of FIG. 12 when the ZVS method of the present invention is applied.

FIGS. 13(g)-(i) show schematic views illustrating the variations of the primary current and two secondary currents of FIG. 12 at six steps when the ZVS method of the present invention is applied.

FIG. 14(a) shows a schematic view illustrating another configuration of FIG. 3(d).

FIG. 14(b) shows a schematic view illustrating a synchronous fly-back converter circuit with a regenerative synchronized snubber.

FIGS. 15(a)-(f) show a schematic view illustrating the inductor current direction of FIG. 14(b) when the ZVS method of the present invention is applied.

FIGS. 15(g)-(i) show schematic views illustrating the variations of the primary current, the secondary current and the snubber current of FIG. 14(b) at six steps when the ZVS method of the present invention is applied.

FIG. 16 shows a fly-back converter circuit.

FIGS. 17(a)-(f) show a schematic view illustrating the inductor current direction of FIG. 16 when the ZVS method of the present invention is applied.

FIGS. 17(g)-(i) show schematic views illustrating the variations of the two primary currents and the secondary current of FIG. 16 at six steps when the ZVS method of the present invention is applied.

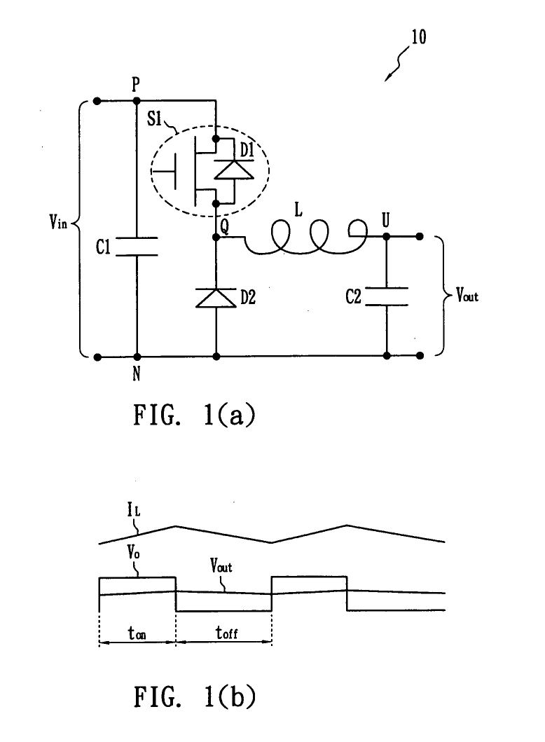

### DETAILED DESCRIPTION OF THE INVENTION

The following description starts from the basic structure of the present invention, followed by its derivates and applications. The real application may use any composition of the basic invention or its derivative techniques, and it may repeatedly be used in different combinations.

The key idea of the present invention works on synchronous converters, in which the synchronous switch is controlled beyond the range of prior art; that is, negative conduction mode.

Some terms used hereinafter are defined as follows. The term “switch module” means a MOSFET connected to a diode in parallel. The term “active” refers to the period in which the MOSFET of the switch module is turned on to be conductive, allowing a current to flow through. The term “passive” is defined as the period in which the switch module allows a current to flow through the diode of the switch module only in one direction. The term “open” or “opened,” means the switch module is non-conductive. When a current turns negative, it means the current reverses. The term “current upper limit CUL” implies a positive value, and the term “current lower limit CLL” implies a negative value.

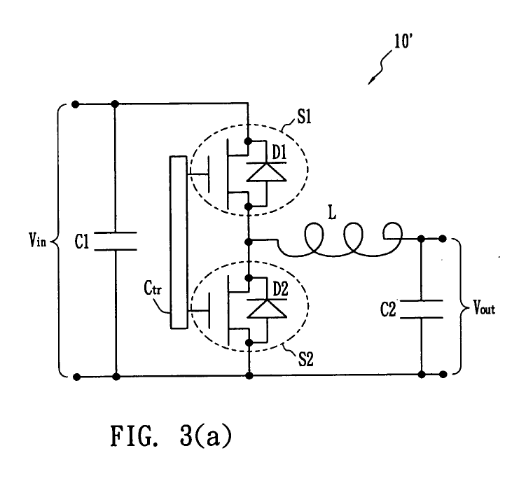

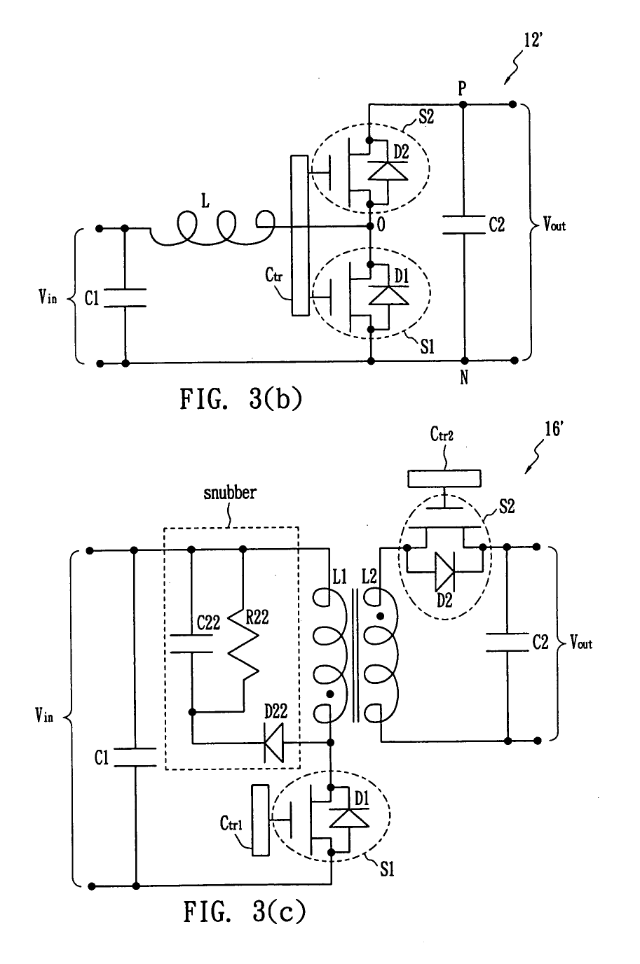

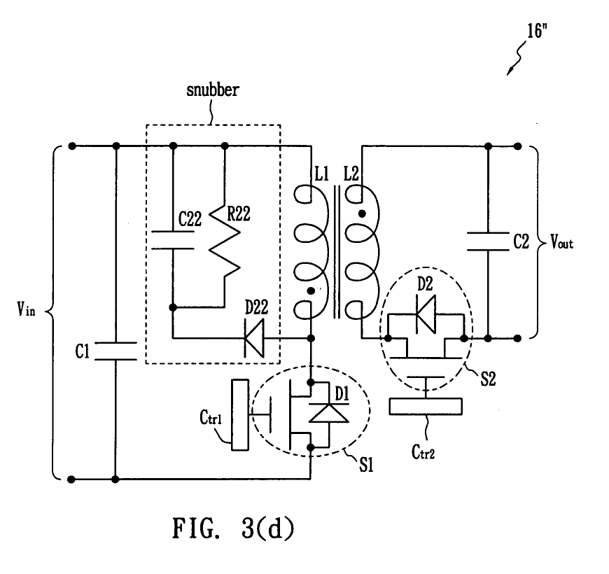

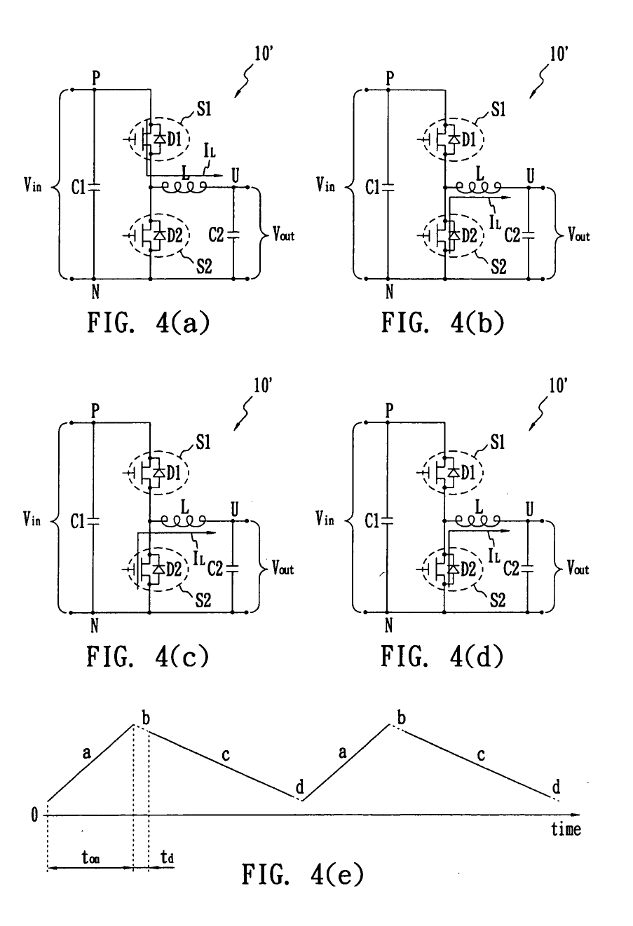

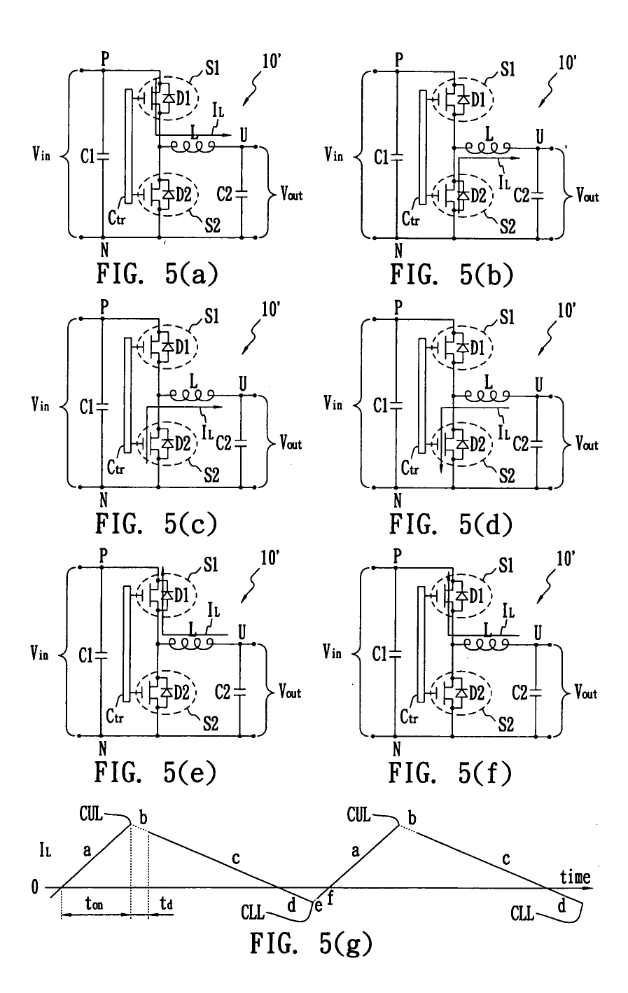

Referring to FIGS. 5(a)-5(g), when the ZVS method of the present invention is applied in a synchronous buck converter circuit 10′ (refer to FIG. 3(a)), the variations of an inductor current I_{L} (the current flowing through the inductor L) from step a to step f are shown in FIG. 5(e), with their current's directions shown in FIGS. 5(a)-5(f). The detail is described as follows. When the first switch module S1 is active, the inductor current I_{L} flows from the node P through the MOSFET of the first switch module S1 and the inductor L to the output. The inductor current I_{L} is linearly increasing to a current upper limit CUL, as shown in FIG. 5(a) and FIG. 5(g). After tₒₙ duration, the first switch module S1 is opened; to keep the inductor current I_{L} continuous, the inductor current I_{L} is fly-wheeling through the diode D2 of the second switch module S2 (i.e., S2 is passive), as shown in FIG. 5(b) and FIG. 5(g). After this, the voltage across the second switch module S2 is zero. In this period, the inductor current I_{L} is linearly decreasing (the dashed line of step b means the state of the current changes from increasing to decreasing). After a short dead t_{d} period, the second switch module S2 is active, and most of the inductor current I_{L} is now diverted through the MOSFET of the second switch module S2, since the MOSFET of the second switch module S2 has a lower voltage drop than the diode D2, as shown in FIG. 5(c) and FIG. 5(g). Meanwhile, the inductor current I_{L} is still decreasing. In this method of the present invention, the second switch module S2 is not opened until the inductor current I_{L} is reversed (i.e., the inductor current I_{L} turns negative), as shown in FIG. 5(d) and FIG. 5(g). Only in this state is the second switch module S2 opened, so the inductor current I_{L} is diverted from a current lower limit CLL to the diode D1 of the first switch module S1 (i.e., S1 is passive), and the voltage across the first switch module S1 is diminished, as shown in FIG. 5(e) and FIG. 5(g) (the dashed line of step e means the state of the current changes from decreasing to increasing), so the first switch module S1 may be turned active with zero voltage for the next cycle, as shown in FIG. 5(f) and FIG. 5(g). Using this method, the inductance of the inductor L should not be too large, for it will take time to wait for the inductor current I_{L} to reverse, and then the switching frequency will be too low. The reverse current does not need to be large, just enough to turn on the diode D1 of the first switch module S1, so the conduction and inductor's core loss are kept to a minimum, comparable to that of the transition conduction mode. In the ZVS method of the present invention, the average of the inductor current I_{L} is controlled.

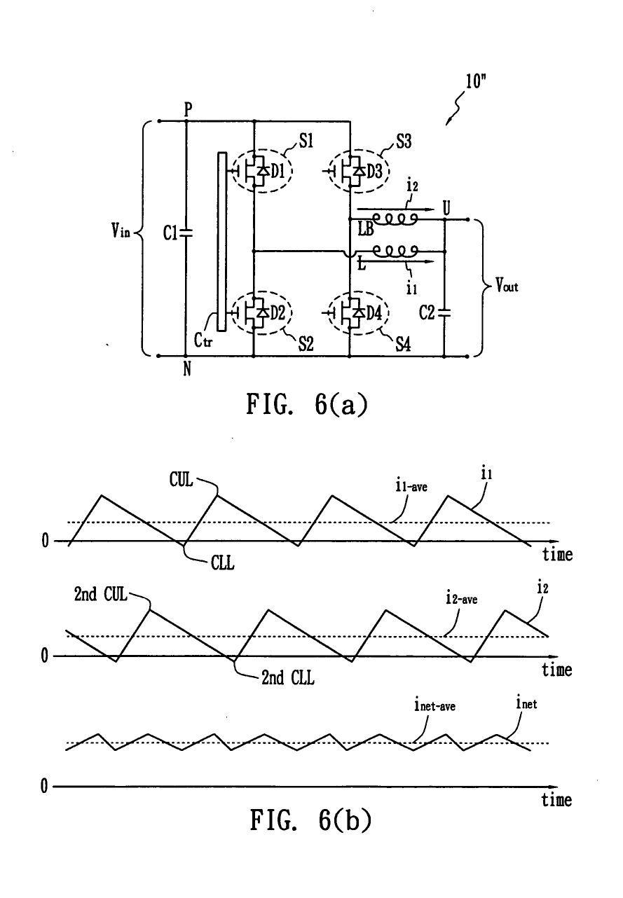

The application of the present invention on the synchronous buck converter circuit 10′ is good for the voltage regulation module (VRM on motherboard PC). One improvement to cover its drawback, a large ripple current, is to design it as a multiphase converter. FIG. 6(a) shows a dual-phase converter circuit 10″, in which the ripple currents (flowing through the inductor L and LB) of i1 and i2 are cancelled out, so the net current iₙₑₜ improves tremendously, as shown in FIG. 6(b). The dual-phase converter circuit 10″ is similar to the synchronous buck converter circuit 10′. A third switch module S3, a fourth switch module S4 and a second inductor LB are added and configured as FIG. 6(a). When the ZVS method of the present invention is applied to the dual-phase converter circuit 10″, the ZVS method comprises the steps of: (a) increasing an inductor current i₁ to a current upper limit CUL with a first switch module S1 active; (a′) increasing a second inductor current i₂ to a second current upper limit 2nd CUL with a third switch module S3 active; (b) decreasing the inductor current i₁ with the first switch module S1 open and a second switch module S2 passive; (b′) decreasing the second inductor current i₂ with the third switch module S3 open and a fourth switch module S4 passive; (c) decreasing the inductor current i₁ with a second switch module S2 active; (c′) decreasing the second inductor current i₂ with the fourth switch module S4 active; (d) turning the second switch module S2 open when the inductor current i₁ turns negative; (d′) turning the fourth switch module S4 open when the second inductor current i₂ turns negative; (e) increasing the inductor current i₁ from a current lower limit CLL with the first switch module S1 passive; (e′) increasing the second inductor current i₂ from a second current lower limit 2_{nd} CLL with the third switch module S3 passive; (f) increasing the inductor current i₁ with the first switch module S1 active with zero voltage; and (f′) increasing the second inductor current i₂ with the third switch module S3 active with zero voltage. In the ZVS method of the present invention, the average of the inductor current i₁, i₁₋ₐᵥₑ, and the average of the second inductor current i₂, i₂₋ₐᵥₑ, are controlled.

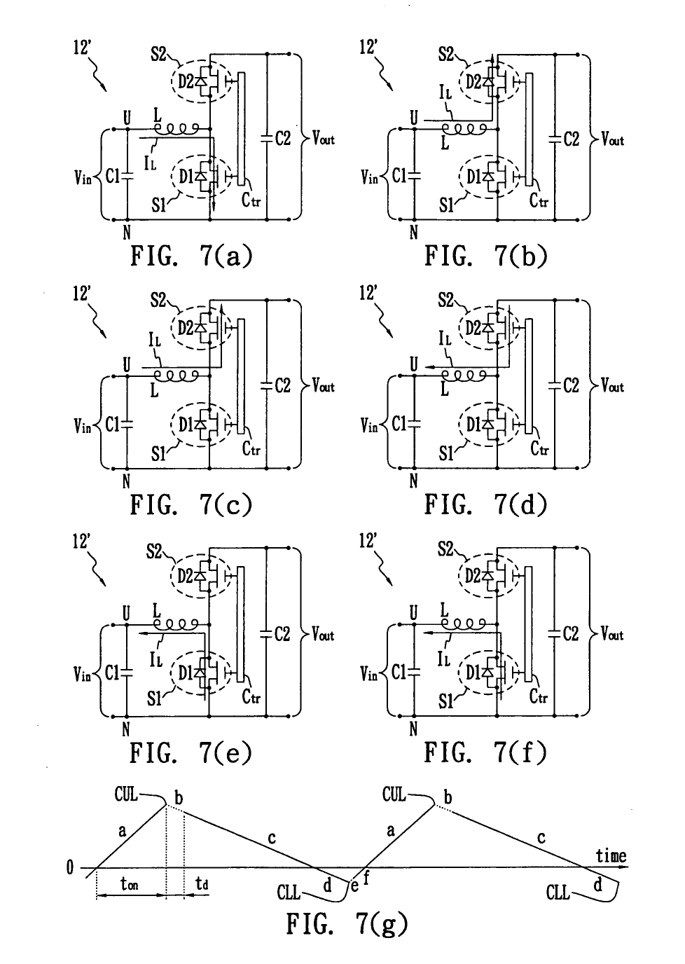

Referring to FIGS. 7(a)-7(g), when the ZVS method of the present invention is applied in a synchronous boost converter circuit 12′ (refer to FIG. 3(b)), the variations of an inductor current (I_{L}) from step a to step f are shown in FIG. 7(e), with their current's directions shown in FIGS. 7(a)-7(f), respectively. The detail is described as follows. When the first switch module S1 is active, the inductor current I_{L} (the current flowing through the inductor L) flows from the node U through the inductor L and the first switch module S1 to the node N. The inductor current I_{L} is linearly increasing to a current upper limit CUL, as shown in FIG. 7(a) and FIG. 7(g). After tₒₙ duration, the switch module S1 is opened; so as to keep the inductor current I_{L} continuous, the inductor current I_{L} is fly-wheeling through the diode D2 of the second switch module S2 (i.e., S2 is passive), and the voltage across the second switch module S2 is zero, as shown in FIG. 7(b) and FIG. 7(g). In this period, the inductor current I_{L} is linearly decreasing (the dashed line of step b means the state of the current changes from increasing to decreasing). After a short dead t_{d} period, the second switch module S2 is active, so most of the inductor current I_{L} is now diverted through the MOSFET of the second switch module S2, since the MOSFET of the second switch module S2 has a lower voltage drop than the diode D2, as shown in FIG. 7(c) and FIG. 7(g). Meanwhile, the inductor current I_{L} is still decreasing. The ZVS method of the present invention does not turn the second switch module S2 open until the inductor current I_{L} reverses (i.e., the inductor current I_{L} turns negative), as shown in FIGS. 7(d) and 7(g). At this state, the second switch module S2 is opened, so the inductor current I_{L} is diverted from a current lower limit CLL to the diode D1 of the first switch module S1 (i.e., S1 is passive), and the voltage across the first switch module S1 is zero, as shown in FIG. 7(e) and FIG. 7(g) (the dashed line of step e means the state of the current changes from decreasing to increasing). Then, the first switch module S1 may be turned active with zero voltage, as shown in FIG. 7(f) and FIG. 7(g). The next cycle is repeated. In the ZVS method of the present invention, the average of the inductor current I_{L} is controlled.

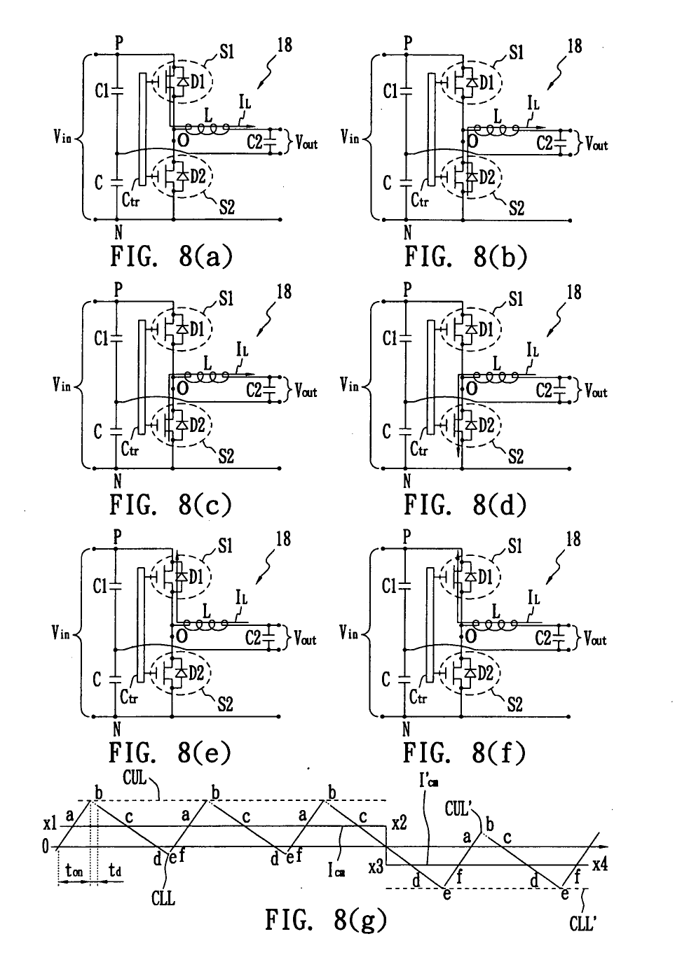

The similarity between a synchronous buck converter circuit 10′ shown in FIG. 3(a) and an inverter circuit suggests the applicability of this method of the present invention for a DC/AC inverter. However, a capacitor C must be connected after the inductor L. The ZVS method of the present invention is suitable for low-frequency inverters, such as motor drives or uninterruptible power supplies, in which low-frequency AC current or voltage output is controlled. This may be accomplished with a bridge circuit. The simplest form of bridge circuit is called a half-bridge. A half-bridge DC/AC inverter 18 is shown in FIG. 8(a).

Referring to FIGS. 8(a)-8(g), when the ZVS method of the present invention is applied in a half-bridge DC/AC inverter, the variations of an inductor current I_{L} from step a to step f are shown in FIG. 8(g), with their current's directions shown in FIGS. 8(a)-8(f), respectively. The detail is described as follows. When the first switch module S1 is active, the inductor current I_{L} (the current flowing through the inductor L) flows from the node P through the MOSFET of the first switch module S1 and the inductor L to the output. It is linearly increasing to a current upper limit CUL, as shown in FIG. 8(a) and FIG. 8(g). After tₒₙ duration, the first switch module S1 is opened; so as to keep the inductor current I_{L} continuous, the inductor current I_{L} fly-wheels through the diode D2 of the second switch module S2 (i.e., S2 is passive), as shown in FIG. 8(b) and FIG. 8(g). After this, the voltage across the second switch module S2 is zero. In this period, the inductor current I_{L} is linearly decreasing (the dashed line of step b means the state of the current changes from increasing to decreasing). After a short dead t_{d} period, the second switch module S2 turns active, and most of the inductor current I_{L} is now diverted through the MOSFET of the second switch module S2, since the MOSFET of the second switch module S2 has a lower voltage drop than the diode D2, as shown in FIG. 8(c) and FIG. 8(g). Meanwhile, the inductor current I_{L} is decreasing. In this method, the second switch module S2 is not opened until the inductor current I_{L} reverses (i.e., the inductor current I_{L} turns negative), as shown in FIG. 8(d) and FIG. 8(g). At this state, the second switch module S2 is opened, so the inductor current I_{L} is diverted from a current lower limit CLL to the diode D1, and the voltage across the first switch module S1 is diminished, as shown in FIG. 8(e) and FIG. 8(g) (the dashed line of step e means the state of the current changes from decreasing to increasing). Then, the first switch module S1 may turn active with zero voltage for the next cycle, as shown in FIG. 8(f) and FIG. 8(g). By controlling the current upper limit CUL(CUL′) and the current lower limit CLL(CLL′); the low-frequency average current may be manipulated, as shown in the line segments x1-x2, x3-x4 in FIG. 8(g), wherein I_{cm} (I′_{cm}) is the average current of the inductor current. As long as the current upper limit CUL and the current lower limit CLL are positive and negative values, respectively, the ZVS method may be achieved. Moreover, the implementation of the present invention on a full-bridge inverter has more advantages in that the current ripple is smaller and switching frequency can be kept constant in a range of load.

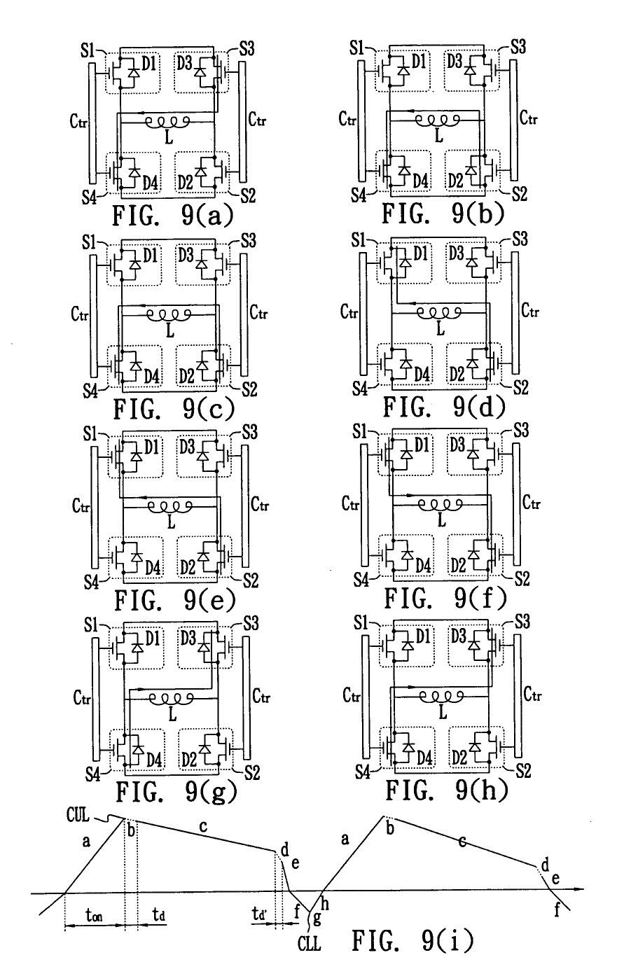

Referring to FIGS. 9(a)-9(i), when the ZVS method of the present invention is applied in a full-bridge DC/AC inverter, the variations of an inductor current I_{L} (the current flowing through the inductor L) from step a to step h are shown in FIG. 9(i), with their current's directions shown in FIGS. 9(a)-9(h), respectively. The detail is described as follows. When the third switch module S3 and the fourth switch module S4 are active, the inductor current I_{L} increases to a current upper limit CUL as step a in FIG. 9(i) and FIG. 9(a). After tₒₙ duration, the third switch module S3 is open; so to keep the inductor current I_{L} continues, the inductor current I_{L} free wheels through the diode D2 as step b in FIG. 9(i) and FIG. 9(b). After a short dead t_{d} period, the second switch module S2 is active, so the conduction loss is less, shown as step c in FIG. 9(i) and FIG. (c). During this time period, the inductor current I_{L} is decreasing. Before it reverses in direction, the fourth switch module S4 should be open and then the inductor current I_{L} detours to the diode D1, as step d in FIG. 9(d). After a short dead t_{d} period, the second switch module S2 may be active with zero voltage. After this stage, the inductor current I_{L} is rapidly decreasing and reversing, as step e in FIG. 9(i) and FIG. 9(e). Once the inductor current I_{L} reverses as step f, the second switch module S2 and the third switch module S3 are open; so the inductor current I_{L} is diverted through the diodes D3 and D4, as step g in FIG. 9(i) and FIG. 9(g). Then, the third switch module S3 and the fourth switch module S4 may be turn active with zero voltage switch, as step h in FIG. 9(i) and FIG. 9(h), and the cycle is repeated. In the ZVS method of the present invention, the average of the inductor current I_{L} is controlled.

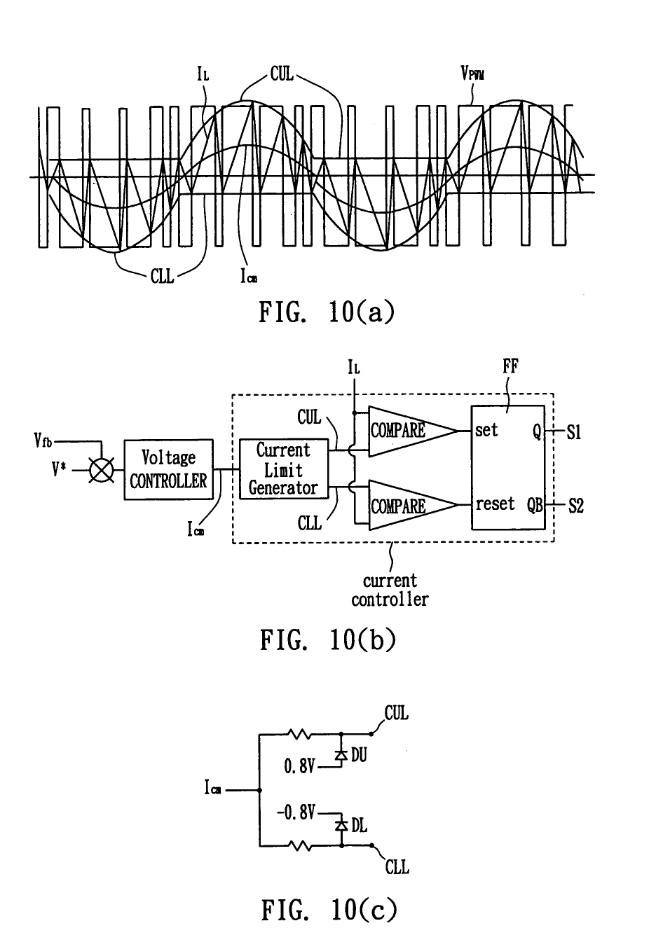

The output current or output voltage of the half-bridge DC/AC inverter 18 may be controlled to any waveform, but mostly as a sinusoidal or square waveform. In these low-frequency output inverters such as the half-bridge DC/AC inverter 18, a cycle of output waveform is controlled through tens or hundreds of cycles of controlled duty switching. FIG. 8(g) (for square waveform output) and FIG. 10(a) (for sinusoidal waveform output) show the open-loop control scheme of the output current applications, which is described as follows. Referring to FIG. 8(g), first, providing a target current I_{cm} (I′_{cm})(i.e., the line segments x1-x2 and x3-x4). Then, providing a current upper limit CUL based on the target current I_{cm} and providing a current lower limit CLL, a little negative value. The current upper limit CUL may be set to a little higher than twice the target current I_{cm}, which is a positive value so the target current I_{cm} is the average of the current upper limit CUL and the current lower limit CLL. Then, the current lower limit CLL can be obtained, in which V_{pwm} is the voltage waveform at the node O of FIG. 8(a). In the ZVS method of the present invention, the average of the inductor current I_{L}, that is, I_{cm}, is controlled.

A closed-loop control scheme of the output voltage applications is shown as FIG. 10(b). V* is the target voltage. V_{fb} is the output voltage feedback. Their difference, the voltage error, is fed into a voltage controller to produce a target current, I_{CM}. From the target current I_{CM}, the current upper limit CUL and the current lower limit CLL are produced by a current limit generator of FIG. 10(c). The current upper limit CUL and the current lower limit CLL are compared with the current feedback I_{L}. When the current feedback I_{L} is equal to or higher than the current upper limit CUL, the flip-flop FF is set and then the first switch module S1 of the half-bridge DC/AC inverter 18 (refer to FIG. 8(a)) is opened and the second switch module S2 of the half-bridge DC/AC inverter 18 (refer to FIG. 8(a)) is active. When the current feedback I_{L} is equal to or lower than the current lower limit CLL, the flip-flop FF is reset and the first switch module S1 of the half-bridge DC/AC inverter 18 is active and the second switch module S2 of the half-bridge DC/AC inverter 18 is open. The current upper limit CUL and the current lower limit CLL are always positive and negative respectively, so the zero voltage switch method is achieved.

For open loop output current control, the current upper limit CUL may be set to twice the target current I_{CM}. For closed loop current controls, the method is the same as that of voltage controls, but with filter current feedback instead of voltage feedback. One may mix these two methods, first as feed forward, and the second as feedback correction. Their components may be adjusted as parameters.

The current upper limit CUL and the current lower limit CLL can be produced using a simple circuit as shown in FIG. 10(c). The current upper limit CUL is about 2× current command, I_{CM}. When I_{CM} is positive, the diode DU is reversed so CUL is equal to I_{CM}, and the diode DL conducts so CLL is clamped at −0.8V+0.7V=−0.1V. When I_{CM} is negative, the diode DL is reversed so CLL is equal to I_{CM}, and the diode DU conducts so CUL is clamped at 0.8V−0.7V=0.1V.

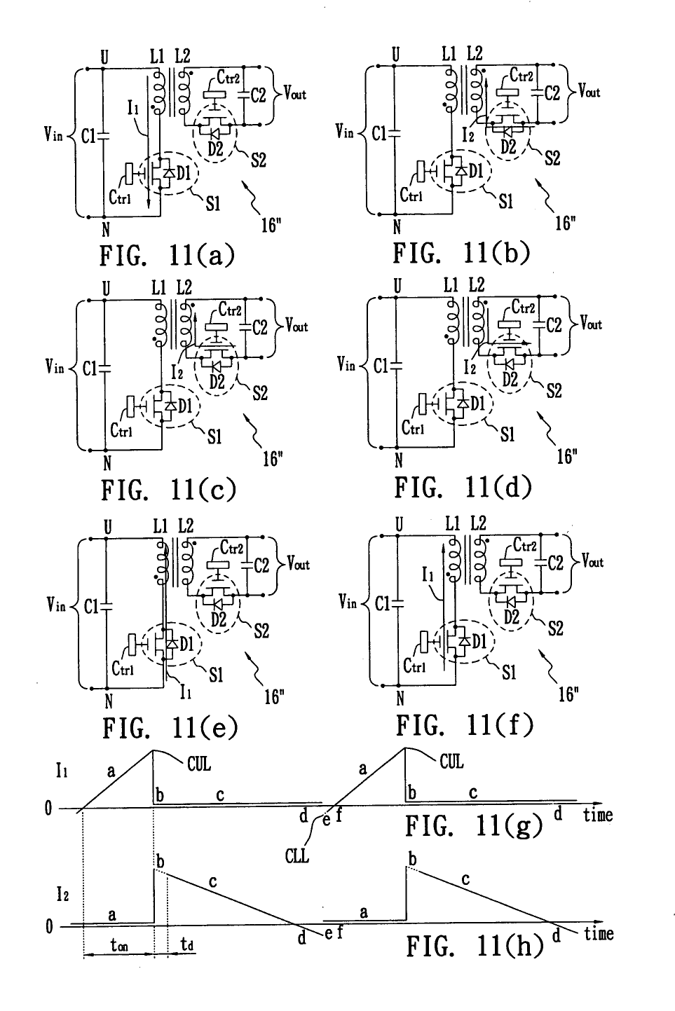

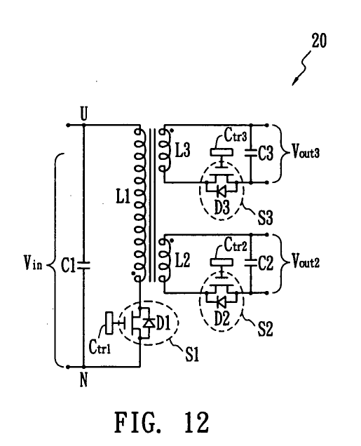

Referring to FIGS. 11(a)-11(g), when the ZVS method of the present invention is applied in a synchronous fly-back transformer circuit 16″ in FIG. 3(d), the switching control and its current variations of a first current I1 (i.e., the primary current flowing through the primary winding L1) and a second current I2 (i.e., the secondary current flowing through the secondary winding L2) from step a to step f are shown in FIG. 11(g) and FIG. 11(h), respectively, with the current directions shown in FIGS. 11(a)-11(f). The detail is described as follows. When the first switch module S1 is active, the first current I1 flows from the node U through the primary winding L1 and the MOSFET of the first switch module S1 to the node N. It is linearly increasing to a current upper limit CUL, as shown in FIG. 11(a) and FIG. 11(g), and the energy is stored as magnetic flux in the synchronous fly-back transformer circuit 16″. After tₒₙ duration, the first switch module S1 is opened. To keep the transformer's flux continuous, the second current I2 (fly-back current) appears on the secondary winding L2 through the diode D2 of the second switch module S2 (i.e., S2 is passive) to the output, and the voltage across the second switch module S2 is zero, as shown in FIG. 11(b) and FIG. 11(h). In this period, the second current I2 is linearly decreasing, while the energy is released to the output. After a short dead t_{d} period, the second switch module S2 turns active, so most of the second current I2 is now diverted through the MOSFET of the second switch module S2, since the MOSFET of the second switch module S2 has a lower voltage drop than the diode D2, as shown in FIG. 11(c) and FIG. 11(h). In this method, the second switch module S2 is not opened until the second current I2 eventually turns negative, as shown in FIGS. 11(d) and 11(h). At this state, the second switch module S2 is opened, so the first current I1 (i.e., a fly-back current in nature) appears from a current lower limit CLL on the primary winding L1, through the diode D1, as shown in FIG. 11(e) and FIG. 11(g). Then, the first switch module S1 may be turned active with zero voltage for the next cycle, as shown in FIG. 11(f) and FIG. 11(g). Again, the reverse current should not be too large, since it will lower the efficiency, and more importantly, it may cause a negative voltage spike on the secondary, due to transformer leakage.

As for a dual-output synchronized rectifier converter 20 (refer to FIG. 12), at the beginning of the fly-back cycle is a transient ring voltage. The problem with prior multi-output diode rectifiers is that for a heavy load output, this transient voltage is consumed, but for a light load output, this transient voltage is not completely consumed, and since the rectified diode does not allow current to return, light load output comes out with higher voltage. The impedance of the rectifier circuit is still another crucial cause of the voltage drop at the output of heavy load. At the beginning of the fly-back cycle, where the current is larger, the output is higher. So for a dual-output diode rectifier, the light load diode conducts only at the beginning of the cycle. The light load output voltage appears higher than that of heavy load.

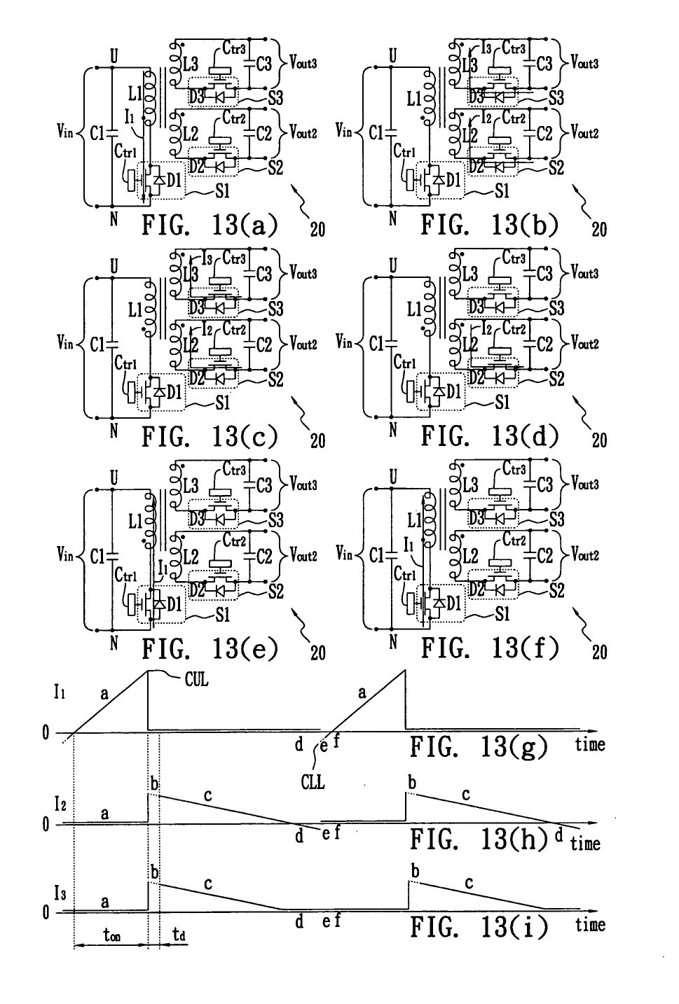

Referring to FIGS. 13(a)-13(i), when the ZVS method of the present invention is applied in a dual-output synchronized rectifier converter 20 in FIG. 12, the current variations of a first current I1 (the primary current flowing through the primary winding L1), a second current I2 (the secondary current flowing through the secondary winding L2) and a third current I3 (the secondary current flowing through the secondary winding L3) from step a to step f are shown in FIGS. 13(g), 13(h) and 13(i), respectively, with the current directions shown in FIGS. 13(a)-13(f). The detail is described as follows. When the first switch module S1 is active, the first current I1 flows from the node U through the primary winding L1 and the MOSFET of the first switch module S1 to the node N. It is linearly increasing to a current upper limit CUL, as shown in FIGS. 13(a) and 13(g). After tₒₙ duration, the first switch module S1 is opened. To keep the transformer's flux continuous, the second current I2 and the third current I3 (fly-back currents) appear on the secondary windings L2 and L3, through the respective diode D2 and D3 to their outputs (i.e., S2 and S3 are passive), as shown in FIG. 13(b), FIG. 13(h) and FIG. 13(i). After this, the voltage across the second switch module S2 and the third switch module S3 is zero. In this period, the second current I2 and the third current I3 are linearly decreasing. After a short dead td period, the second switch module S2 and the third switch module S3 are active, so most of the currents are now diverted through the MOSFET of the second switch module S2 and the MOSFET of the third switch module S3, since they have lower voltage drops than the diodes (D2 and D3, respectively), as shown in FIG. 13(c), FIG. 13(h) and FIG. 13(i). Unlike the diode rectifier, since the second switch module S2 and the third switch module S3 allow currents to flow in both directions, the voltage of the outputs will equalize themselves during this period, assuming that the output voltages are proportional to the winding turns. In fact, cross regulation is good enough by simply controlling the second switch module S2 and the third switch module S3 simultaneously, neglecting the impedance. To have more accurate output voltages, the impedance voltage drop should be taken care, since in general the output loads are not the same. The controller needs to control the switch modules of the respective outputs separately, by turning off the switch module of the heaviest load first, followed by that of the lighter load. Finally when the latter switch module, that of the lightest loads, is turned off, its current has been reversed. For example, if the third switch module S3 has the heaviest load, it is turned off first (i.e., S3 is opened first). Then, the second switch module S2 is turned off (i.e., S2 is opened) just after the second current I2 turns negative, as shown in FIG. 13(d) and FIG. 13(h). As the flux is continuous, the secondary net reverse current appears from a current lower limit CLL as the first current I1 (a fly-back current) on the primary winding L1, though the diode D1, as shown in FIG. 13(e). Then, the first switch module S1 turns active with zero voltage for the next cycle, as in FIG. 13(f). Some of the extra energy of the light load output has a chance to transfer to the heavy load output, and some transfers (fly-backs) to the primary winding L1 to regenerate. The latter should be kept small, since it will be less efficient, and it will cause a large negative voltage spike on the light load's switch module, because of the leakage inductance, or another snubber circuit must be added. This control also works (but less efficiently) with the diode rectifier (without MOSFET) on the heavy load output.

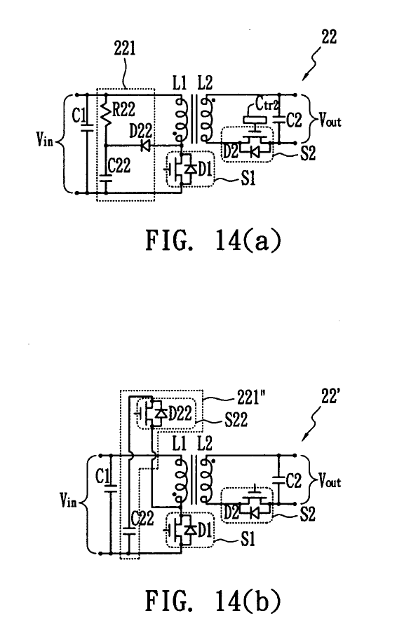

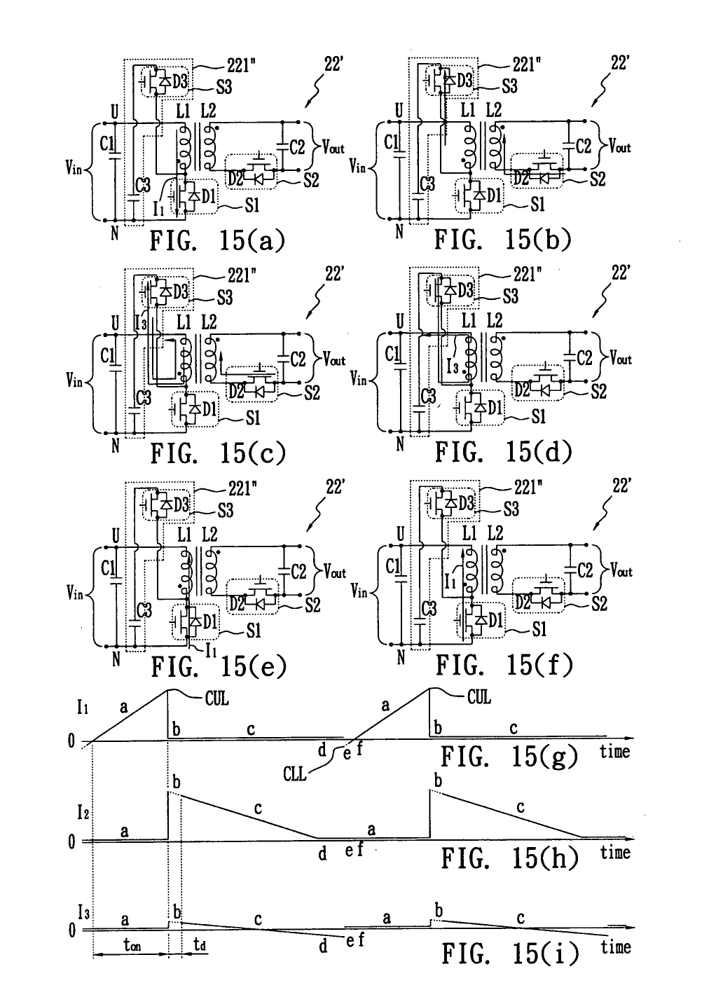

Referring to the synchronous fly-back transformer circuit 16″ in FIG. 3(d), the prior snubber circuit may be regarded as another output with a diode rectifier and dummy resistive load, and the primary winding L1 works also as output winding (the basic non-isolated fly-back). A capacitor C22 of FIG. 3(d) may also be connected as the capacitor C22 of a snubber 221, shown in FIG. 14(a). Then, by replacing the snubber diode D22 with a switch module, the snubber energy, which is disposed as heat in prior art, now may be transferred to the load, and it is also used to facilitate the ZVS method, referring to FIG. 14(b). Therefore, the ZVS method of the present invention may also be applied for a regenerative synchronized snubber 221′ of a synchronous fly-back converter circuit 22, as shown in FIG. 14(b). Referring to FIGS. 15(a)-15(i), the switching control and the current variations of a first current I1 (i.e., the primary current flowing through the first switch module S1), a second current I2 (i.e., the secondary current flowing through the second winding L2) and a third current I3 (i.e., the snubber current flowing through the snubber circuit 221″) from step a to step f are shown in FIG. 15(g), FIG. 15(h) and FIG. 15(i), respectively, with the current directions shown in FIGS. 15(a)-15(f). The detail is described as follows. When the first switch module S1 is active, the first current I1 flows from the node U through the primary winding L1 and the MOSFET of the first switch module S1 to the node N. It is linearly increasing to a current upper limit CUL, as shown in FIG. 15(a) and FIG. 15(g), and the energy is stored as magnetic flux in the fly-back transformer. After tₒₙ duration, the first switch module S1 is opened. To keep the transformer's flux continuous, the third current I3 (a fly-back current) in the primary winding L1 passes through the diode D3 (i.e., S3 is passive) to the capacitor C3, and at the same time, the second current I2 also appears on the secondary winding L2, through the diode D2 (i.e., S2 is passive) to the output, and the voltage across the second switch module S2 and the third switch module S3 is zero, as shown in FIG. 15(b) and step b in FIG. 15(h) and FIG. 15(i). In this period, the third current I3 is linearly decreasing. After a short dead t_{d} period, the third switch module S3 and the second switch module S2 are both active, so most of the third current I3 (the second current I2) is now diverted through the MOSFET of the third switch module S3 (the MOSFET of the second switch module S2), since the MOSFET of the third switch module S3 (the MOSFET of the second switch module S2) has a lower voltage drop than that of the diode D3 (the diode D2), as shown in FIG. 15(c) and step c in FIG. 15(h) and FIG. 15(i). In this time period, both the second switch module S2 and the third switch module S3 are active, so the energy that is just dumped into the capacitor C3 is transferred to the secondary side; that is, the third current I3 turns negative. The voltage balances between the capacitor C3 and the capacitor C2. When the second current I2 on the second switch module S2 diminishes to zero, the second switch module S2 is turn off and the third switch module S3 follows, as shown in FIG. 15(d) and step d in FIG. 15(h) and FIG. 15(i). So the third switch module S3 is opened, when the third current I3 is reversing. So the current will be diverted from a current lower limit CLL though the diode D1 of the first switch module S1 (i.e., S1 is passive), as shown in FIG. 15(e) and FIG. 15(g). Then the first switch module S1 may be active with zero voltage for the next cycle, as shown in FIG. 15(f) and FIG. 15(g). This method also works (but less efficiently) with the diode rectifier (without MOSFET) on the secondary side.

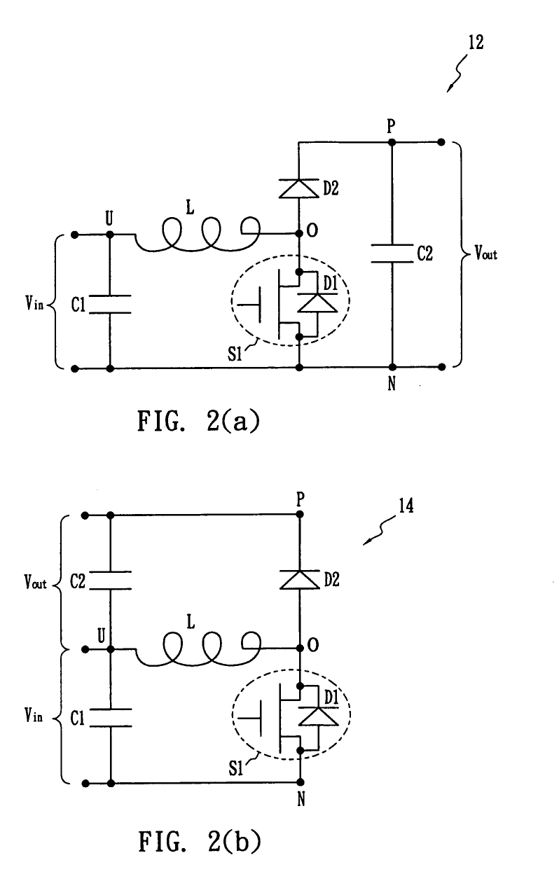

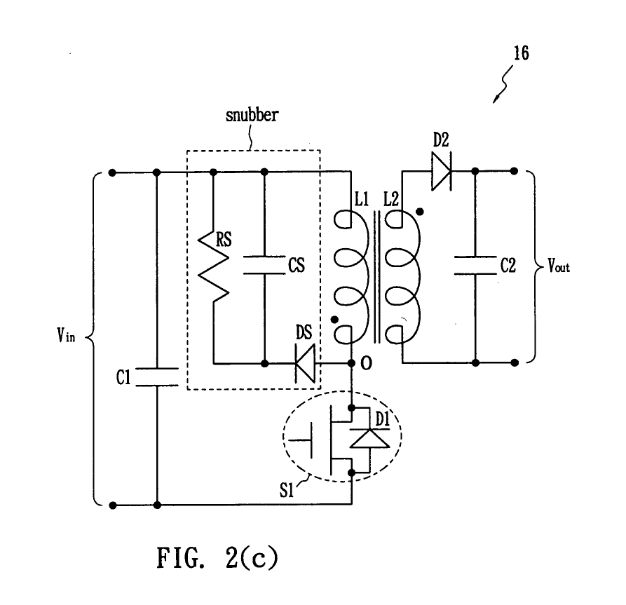

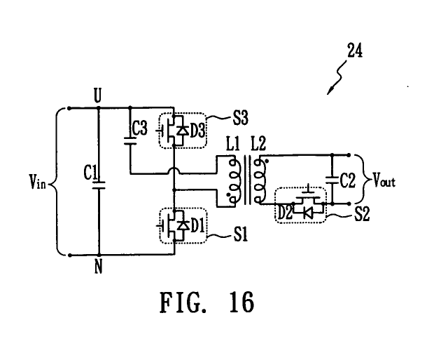

FIG. 16 shows a fly-back converter circuit 24 derived from FIG. 2(b) and FIG. 14(b). The fly-back converter circuit 24 is useful when the voltage of primary available switches is only a little higher than that of the input. For example, in the 440VAC system, the rectified voltage is about 622VDC. The design of a prior-art fly-back converter with this input needs a 1200V rated MOSFET. But with the fly-back converter circuit 24 in FIG. 16, a 700V rated MOSFET is enough, and ZVS is achieved. The fly-back converter circuit 24 looks like a half-bridge fly-back converter, but from the way it is controlled, it may be called a suspended-input fly-back converter. A capacitor C3 is the suspending capacitor of the non-isolated buck buffer.

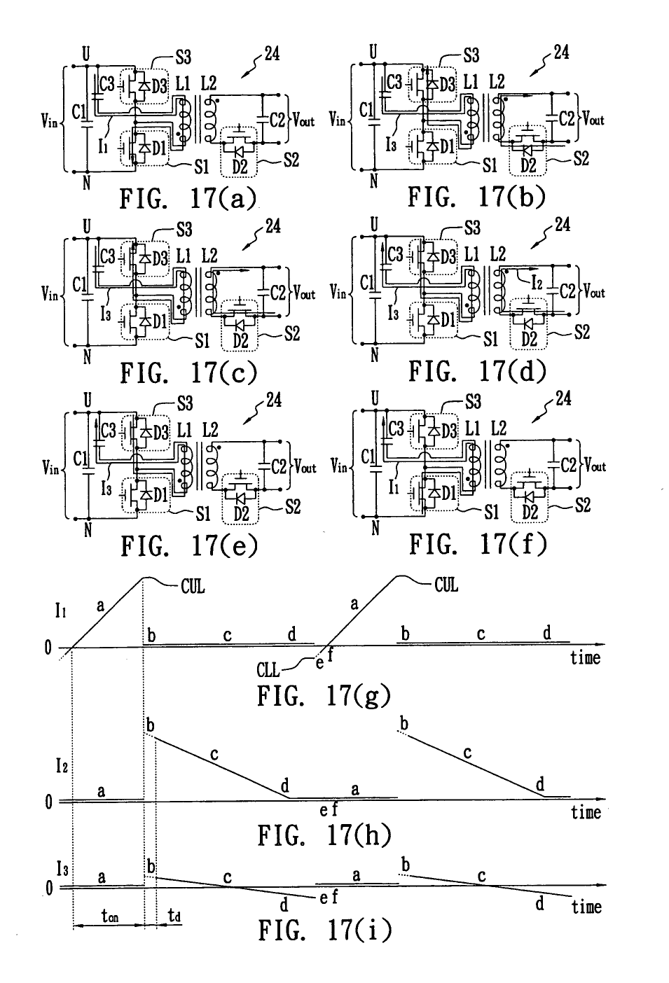

Referring to FIGS. 17(a)-17(i), when the ZVS method of the present invention is applied in the half-bridge fly-back converter circuit 24, the switching control and its current variations of the first current I1 (the primary current flowing through the first switch module S1 and the primary winding L1), the second current I2 (the secondary current flowing through the secondary winding L2) and the third current I3 (the current flowing through the third switch module S3 and the primary winding L1) from step a to step f are shown in FIGS. 17(g)-17(i), with the current directions shown in FIGS. 17(a)-17(f). The detail is described as follows. When the first switch module S1 is active, the first current I1 flows from the node U through the capacitor C3, the primary winding L1 and the MOSFET of the first switch module S1 to the node N. It is linearly increasing to a current upper limit CUL, as shown in FIG. 17(a) and step a in FIG. 17(g). The energy is stored as magnetic flux in the fly-back transformer and the capacitor C3. After tₒₙ duration, the first switch module S1 is opened. To keep the transformer's flux continuous, the third current I3 (a fly-back current) in the primary winding L1 passes through the diode D3 of the third switch module S3 (i.e., S3 is passive) to the capacitor C3, and at the same time, the second current I2 also appears on the secondary winding L2, through the diode D2 of the second switch module S2 (i.e., S2 is passive) to the output, and the voltage across the third switch module S3 and the second switch module S2 is zero, as shown in FIG. 17(b) and step b in FIG. 17(h) and FIG. 17(i). In this period, the third current I3 is linearly decreasing, while the energy is released to the buck buffer and output fly-back. After a short dead t_{d} period, the third switch module S3 and the second switch module S2 are active, so most of the third current I3 (the second current I2) is now diverted through the third switch module S3 (the second switch module S2), since the MOSFET of the third switch module S3 (the MOSFET of the second switch module S2) has a lower voltage drop than that of the diode D3 (the diode D2), as shown in FIG. 17(c) and step c in FIG. 17(h) and FIG. 17(i). In the period when the third switch module S3 is active, the energy that is dumped into the capacitor C3 is transferred to the secondary side, as shown in FIG. 17(d), in which the capacitor C3 reverses from charging to discharging (i.e., the third current I3 reverses). In this method, when the second current I2 goes to zero, the second switch module S2 is opened, then the third switch module S3 follows, as shown in FIG. 17(e). When the third switch module S3 is opened, the first current I1 is diverted though the diode D1 of the first switch module S1 (i.e., S1 is passive), as shown in FIG. 17(f). Then, the first switch module S1 may be turned active with zero voltage for the next cycle. This control also works (but less efficiently) with the diode rectifier (without MOSFET) on the secondary side.

In the above descriptions, when tₒₙ is defined by control time, the control method is called the voltage-controlled mode, but it also works with the current-controlled mode, in which tₒₙ is indirectly determined through a defined current. In a current-controlled mode, the current is sensed and compared with a current command. The MOSFET of a switch module is turned off when sensed current is equal to or larger than command current.

The above-described embodiments of the present invention are intended to be illustrative only. Numerous alternative embodiments may be devised by persons skilled in the art without departing from the scope of the following claims.

I claim:

1. A zero voltage switch method applied in a converter, comprising the steps of:
increasing an inductor current to a current upper limit with a first switch module active;
decreasing the inductor current with the first switch module open and a second switch module passive;
decreasing the inductor current with a second switch module active;
turning the second switch module open when the inductor current turns negative;
increasing the inductor current from a current lower limit with the first switch module passive; and
increasing the inductor current with the first switch module active with zero voltage;
wherein an average of the inductor current is controlled.

2. The zero voltage switch method of claim 1, wherein the converter is a buck converter.

3. The zero voltage switch method of claim 1, wherein the converter is a boost converter.

4. The zero voltage switch method of claim 1, wherein the converter is a DC/AC inverter.

5. The zero voltage switch method of claim 4, further comprising the steps of:
providing a target current;
providing the current upper limit based on the target current; and
providing the current lower limit, a negative value, based on the target current and the current upper limit.

6. The zero voltage switch method of claim 5, wherein the target current is provided based on a target voltage.

7. The zero voltage switch method of claim 1, further comprising the steps of:
increasing a second inductor current to a second current upper limit with a third switch module active, which is after the step of increasing an inductor current to a current upper limit and before the step of decreasing the inductor current with the first switch module open;
decreasing the second inductor current with the third switch module open and a fourth rectifier passive, which is after the step of decreasing the inductor current with the first switch module open and before the step of decreasing the inductor current with a second switch module active;
decreasing the second inductor current with the fourth switch module active, which is after the step of decreasing the inductor current with a second switch module active and before the step of turning the second switch module open;
turning the fourth switch module open when the second inductor current turns negative, which is after the step of turning the second switch module open and before the step increasing the inductor current from a current lower limit;
increasing the second inductor current from a second current lower limit with the third switch module passive, which is after the step of increasing the inductor current from a current lower limit and before the step of increasing the inductor current with the first switch module active; and
increasing the second inductor current with the third switch module active with zero voltage, which is after the step of increasing the inductor current with the first switch module active;
wherein the converter is a dual-phase converter.

8. The zero voltage switch method of claim 1, wherein each of the first switch module and the second switch module comprises a switch connected to a diode in parallel.

9. The zero voltage switch method of claim 7, wherein each of the first switch module, the second switch module, the third switch module and the fourth switch module comprises a switch connected to a diode in parallel.

10. The zero voltage switch method of claim 8, wherein the switch is a MOSFET.

11. The zero voltage switch method of claim 9, wherein the switch is a MOSFET.

12. The zero voltage switch method of claim 1, which performs in current-controlled mode or in voltage-controlled mode.

13. The zero voltage switch method of claim 7, which performs in current-controlled mode or in voltage-controlled mode.

14. A zero voltage switch method applied in a converter, comprising the steps of:
increasing a first current to a current upper limit with a first switch module active;
decreasing a second current with the first switch module open and a second switch module passive;
decreasing the second current with the second switch module active;
turning the second switch module open when the second current turns negative;
increasing the first current from a current lower limit with the first switch module passive; and
increasing the first current with the first switch module active with zero voltage;
wherein an average of the second current is controlled.

15. The zero voltage switch method of claim 14, wherein each of the first switch module and the second switch module comprises a switch connected to a diode in parallel.

16. The zero voltage switch method of claim 15, wherein the switch is a MOSFET.

17. The zero voltage switch method of claim 14, which performs in current-controlled mode or in voltage-controlled mode.

18. The zero voltage switch method of claim 14, further comprising the steps of:
decreasing a third current with the first switch module open and a third switch module passive; and
decreasing the third current with the third switch module active;
wherein the converter is a two-output converter.

19. The zero voltage switch method of claim 18, wherein each of the first switch module, the second switch module and the third switch module comprises a switch connected to a diode in parallel.

20. The zero voltage switch method of claim 18, wherein each of the first switch module and the second switch module comprises a switch connected to a diode, and the third switch module is a diode.

21. The zero voltage switch method of claim 19, wherein the switch is a MOSFET.

22. The zero voltage switch method of claim 20, wherein the switch is a MOSFET.

23. The zero voltage switch method of claim 18, which performs in current-controlled mode or in voltage-controlled mode.

24. A zero voltage switch method applied in a converter, comprising the steps of:
increasing a first current to a current upper limit with a first switch module active;
decreasing a third current with the first switch module open, a second switch module passive and a third switch module passive;
decreasing the third current with the third switch module active and the second switch module active;
turning the second switch module open when the second current turns negative;
increasing the first current from a current lower limit with the third switch module open and the first switch module passive; and
increasing the first current with the first switch module active with zero voltage;
wherein an average of the third current is controlled.

25. The zero voltage switch method of claim 24, wherein each of the first switch module, the second switch module and the third switch module comprises a switch connected to a diode in parallel.

26. The zero voltage switch method of claim 24, wherein each of the first switch module and the third switch module comprises a switch connected to a diode in parallel, and the second switch module is a diode.

27. The zero voltage switch method of claim 25, wherein the switch is a MOSFET.

28. The zero voltage switch method of claim 26, wherein the switch is a MOSFET.

29. The zero voltage switch method of claim 24, wherein the converter is a fly-back converter with a regenerative snubber.

30. The zero voltage switch method of claim 24, wherein the converter is a half-bridge fly-back converter.

31. The zero voltage switch method of claim 24, which performs in the current-controlled mode or in the voltage-controlled mode.

32. A zero voltage switch method applied in a full-bridge DC/AC converter, comprising the steps of:
increasing an inductor current to a current upper limit with a third switch module active and a fourth switch module active;
decreasing the inductor current with the third switch module open and a second switch module passive;
decreasing the inductor current with the second switch module active;
decreasing the inductor current with the fourth switch module open and a first switch module passive;
decreasing the inductor current with the second switch module with zero voltage;
turning the second switch module open and the third switch module open when the inductor current turns negative;
increasing the inductor current from a current lower limit with the third switch module passive and with the fourth switch module passive; and
increasing the inductor current with the third switch module active with zero voltage and with the fourth switch module active with zero voltage;
wherein an average of the inductor current is controlled.

33. The zero voltage switch method of claim 32, wherein each of the first, second, third and fourth switch modules comprises a switch connected to a diode in parallel.

34. The zero voltage switch method of claim 33, wherein the switch is a MOSFET.
